(19) United States
(12) Patent Application Publication
(10) Pub. No.: US 2006/0122872 A1
(43) Pub. Date: Jun. 8, 2006

(54) Graphical user interface for and method of use for a computer-implemented system and method for booking travel itineraries

(76) Inventors: Harold L. Stevens, New York, NY (US); Steven J. Mandelbaum, Washington, DC (US); Emmanuel Azucena, Toronto (CA)

Correspondence Address: WHITE-WELKER & WELKER, LLC, P.O. BOX 199, CLEAR SPRING, MD, 21722-0199, US

(21) Appl. No.: 11/288,561

(22) Filed: Nov. 29, 2005

Related U.S. Application Data
(60) Provisional application No. 60/633,454, filed on Dec. 6, 2004.

(51) Int. Cl. G06Q 10/00

(52) U.S. Cl. 705/5

(57) ABSTRACT

A method and apparatus for purchasing an airline ticket and other travel services that includes entering into a computer, information describing a service such as a flight desired by a consumer. The present invention is embodied via a graphical user interface for a travel planning system is described. The graphical user interface is implemented as a web page and includes a tabular region of the graphical user interface that displays summarized travel options and comprises a plurality of cells that act as controls.

### CROSS REFERENCE TO RELATED APPLICATIONS

This application claims priority from U.S. Provisional Patent Application Ser. No. 60/633,454, entitled “Graphical User Interface for and Method of Use for a Computer-Implemented System and Method for Booking Travel Itineraries”, filed on Dec. 6, 2004.

### FEDERALLY SPONSORED RESEARCH

### Not Applicable

### SEQUENCE LISTING OR PROGRAM

### Not Applicable

### TECHNICAL FIELD OF THE INVENTION

The present invention relates generally to interactive computerized travel planning systems. More specifically the present invention relates to a graphical user interface delivered over a multi-user network enabling a user to select suitable travel services.

### BACKGROUND OF THE INVENTION

There are known in the art interactive travel services on the Internet that allow consumers to purchase travel services on-line. Typically, such services require the consumer to input to the travel service server information that is pertinent to their travel itinerary. The travel service then carries out a search and delivers the results to the user often providing results based on the lowest prices available for the desired or similar service.

For example, the travel service displays to the user a list of flights for which seats are listed as being available at that time, together with the fares for such flights. The user then has the option of purchasing a selected flight from the list, either by transmitting to the service credit card information over the Internet, by calling a telephone number or possibly by transmitting payment information by facsimile.

Conventionally, travel-planning systems are used to produce itineraries and prices by selecting suitable travel units from databases concerning geographic scheduling and pricing information. In particular, travel-planning systems that operate over the Internet are known. Some computer travel planning systems, such as Internet website, generally produce a set of planning options, or itineraries for the traveler to consider. These options are often in the form of a single list of the possible itineraries from which the traveler may select. Such a display approach makes it difficult to clearly compare, discriminate, focus, and assimilate criteria and information that are likely to be important to the traveler.

A system is also known in the prior art whereby a consumer can specify a price at which she is willing to purchase an airline ticket for travel between designated cities. In order to make use of this service, however, the consumer must be willing to make an irrevocable offer, with the possible result that the consumer may have to accept tickets for a flight schedule and time of departure that may be inconvenient or less than desirable. Once a carrier has accepted the consumer's offer, the fare is automatically charged to the consumer's credit card and the consumer is not able to cancel or to receive a refund. As such, the consumer may be stuck with tickets for a flight that is inconvenient, with a carrier that the consumer may wish to avoid, or in a worst case, for a flight at a time that the consumer cannot travel because of unexpected intervening events. Conversely, if the consumer's offer is rejected by all airlines, the request is canceled and the consumer must go through the entire data entry process again to initiate another request.

Many Internet travel services also provide an e-mail service through which subscribers are regularly notified of so-called “lowest fares” available for flights between specified city pairs. However, such fares typically represent the lowest published fares as published in airline tariffs, and do not represent fares actually available on particular flights. As such, it is common that when the consumer accesses an Internet travel service website in response to such an e-mail notification, she will not be able to purchase any tickets for the so-called “lowest published fare” on any actual flight.

There remains a need in the art for an interactive travel service that not only allows the consumer to set her own price for airline travel, but also for a wide variety of services relevant to the travel industry.

For the foregoing reasons, conventional travel planning systems known in the prior art are not provided with functionality for enabling a user to be positively engaged in the planning and management of travel.

### SUMMARY OF THE INVENTION

According to an aspect of the invention, a graphical user interface for a travel planning system includes a tabular region of the graphical user interface that displays summarized travel options and comprises a plurality of cells that act as controls and a second region that displays selected travel options resulting from filtering a set of travel options in accordance with a control actuated in the tabular region.

One or more of the following advantages may be provided by one or more aspect of the present invention. The present invention is designed to be a modern exclusive one-stop interactive computer system, featuring search and select travel services via a multi-user network such as the Internet for consumers and corporations alike. The travel system of the present invention automatically links to the major public and private travel search engines without ever leaving its home website.

The travel system of the present invention overcomes the aforementioned deficiencies in the prior art in addition to saving users valuable time. The present invention is much more efficient when a user desires to search a plurality of travel service providers and even direct travel services such as airlines and car rental agencies. This search engine of the present invention allows a user to search and compare real time rates without the need to search multiple locations. Additionally, the search is performed without the technique of screen scraping.

In addition to providing accurate and real time travel service information and pricing, the system of the present invention contains additional databases for storing information regarding many additional aspects of travel from domestic to international and provides a single platform for not only enabling travel arrangements and reservations but provides a user with unlimited related travel information such as shopping and entertainment opportunities. The advantage of the system of the present invention is that finding such information could take hours or even days to locate via other sources, but through the tab and link system the present invention provides a category organizational system that enables a user to navigate the system in a logical and easy to use manner.

In support of the system's functionality of a one-stop travel-shopping environment, the system also includes functionality, which maintains users' login information for the linked systems and automatically signs them into linked website, thereby eliminating the need for users to remember passwords to other travel website. Additionally, the system provides a dashboard view that (1) allows users to see a history of their previous searches (with capability to re-search a previous criteria), (2) displays travel itineraries booked on all other website, therefore aggregating account and transacting information from multiple website, and (3) tracks and notifies users' of compliance with set travel spending-limit policies when employed as an organizational management system.

The system also features a full reporting and administration feature that allows organizations to report on usage by users in their organization. It further allows subdivision of users within an organization and can display and secure reports by entire organization or subset(s) of subdivisions. Additionally, organizations can administer and run their own reports including spending, detailed travel itineraries from multiple travel sources (i.e.: website), and manage subdivisions, spending-limit policies, and individual users.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram of a client server travel planning system particularly operable over the Internet;

FIG. 2 is a flow diagram of a user login procedure according to one embodiment of the invention;

FIG. 3 is a flow diagram of the auto login feature according to one embodiment of the invention;

FIG. 4 is a flow diagram of a process for presenting fare search results to the user;

FIG. 5 illustrates the GUI physical design and placement of title/labels, tabular data, and navigation logic;

FIG. 6 is an illustration of the GUI design of the Mega Search feature of the present invention;

FIG. 7 is an illustration of the GUI design of the Hot Deals feature of the present invention;

FIG. 8 is a diagram of a query screen for a graphical user interface implemented as a web page from a web browser;

FIG. 9 is a diagram of a web page depicting results of executing a query for a round trip based on information entered through the query screen of FIG. 8;

FIG. 10 is a diagram of the mega search feature according to one embodiment of the invention;

FIG. 11 is a flow chart illustrating the organization of the vendor and user information as provided to the Mega Search Engine;

FIG. 12 is a flow chart that illustrates the steps necessary to proceed from an initiated search to a results display;

FIG. 13 is a process diagram of the Mega Search Crawler;

FIG. 14 is a process diagram of the login and parsing of the Web Crawler.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

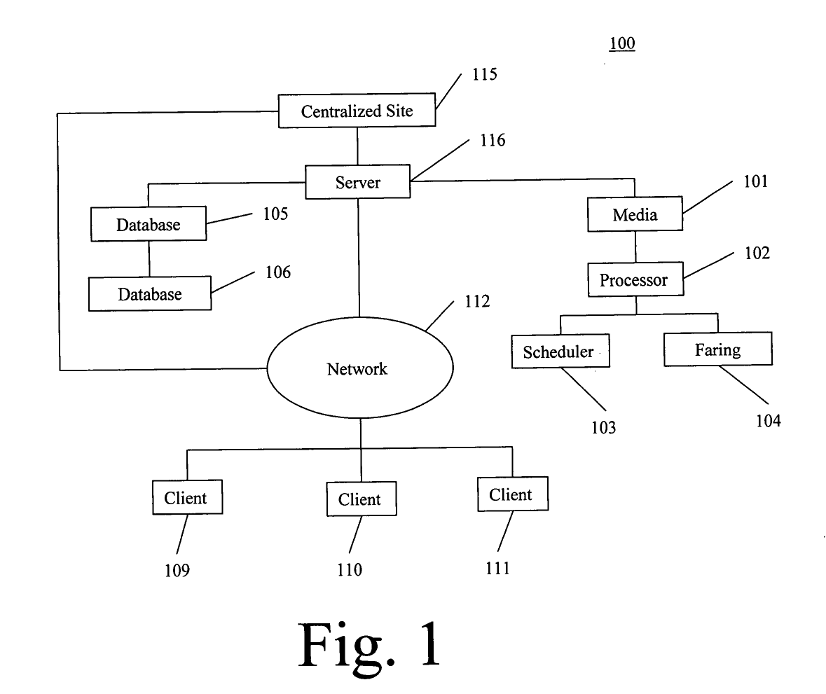

Referring to FIG. 1, a travel planning system 100 is shown. The travel planning system 100 can be used with various forms of travel such as airline, bus and railroad and is particularly adapted for air travel. Travel system 100 can include a server computer 116 having a computer memory or storage media 101 storing a server process 102. The server process 102 can include a scheduler process 103 and a faring process 104. The system 100 can include databases 105 & 106 and these databases 105 & 106 are typically stored locally and updated periodically by accessing remote resources that maintain the respective databases.

The system 100 can also include a plurality of clients 109, 110, & 111 coupled to the server 101 via a network 112. A module may also be included that tracks specific clients by organization and subdivision. This module may also allow said organizations to administer users on their website and view transactions made by said users. Report generation to administrators would be based on each subdivision of each organization. The network 112 can be any local or wide area network or an arrangement such as the Internet. Other travel planning systems such as those on the Internet can also be used.

The use of a centralized website 115 that catalogs and lists all other web resources and website. The system then displays other websites within the centralized catalog's interface and allows clients 109, 110, & 111 to view multiple travel website without leaving the core catalog by docketing the multiple travel websites within the centralized website 115, for easy retrieval and viewing by a tab selection.

The scheduler process 113 provides itineraries to a faring process 114. The faring process provides a set of pricing solutions by finding valid fares corresponding to the itineraries produced by the scheduler process 113. The faring process 114 also validates the fares for inclusion in a set of pricing solutions. The information to have the server produce the set of pricing solutions is obtain from a user entering data in a graphical user interface as will be described below. In addition, the set of pricing solutions are also displayed to the user through the graphical user interface.

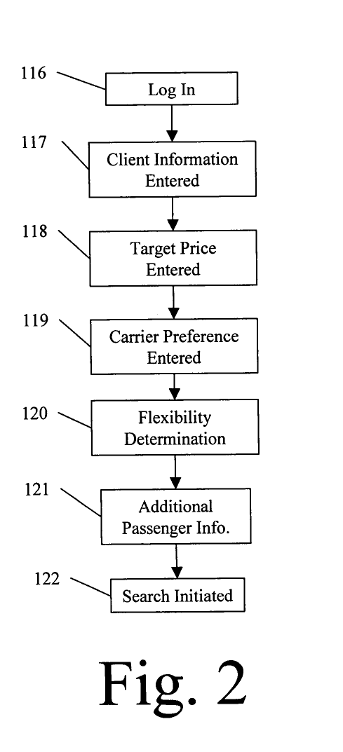

Referring to FIG. 2, a consumer wishing to purchase airline travel tickets “logs in” to the server, such as by inputting the URL of the booking server on the consumer's Web browser, at step 116. At this time, the consumer or user will be presented with a web page containing spaces for information to be entered by the user. At step 117, the user enters as basic request data the departure and destination cities, along with the dates of departure and return. At step 118, the user enters a target price, representing the fare that the user would like to pay for the tickets. After this preliminary data entry, at step 119 the user may enter a carrier preference, or may indicate no preference among airlines by requesting the booking server to search among all air carriers for the best fare.

At step 120, the user may indicate whether her travel plans are flexible, meaning that the user may depart or return from one to three days before or after the entered travel dates. If the user's plans are flexible, the user will indicate whether the flexibility is respect to the date of departure or date of return, and will indicate the number of days either before or after the inputted date of travel. If the user is not flexible, the user will enter “not flexible” in the appropriate line on the web page.

At step 121, the user enters the number and names of additional accompanying passengers, if any, and at step 207, the user requests the booking server to initiate a search for a flight meeting the entered information, which is at or below the user's indicated target price. The booking server also requests the user to input address, telephone and e-mail address information for booking and future communication purposes.

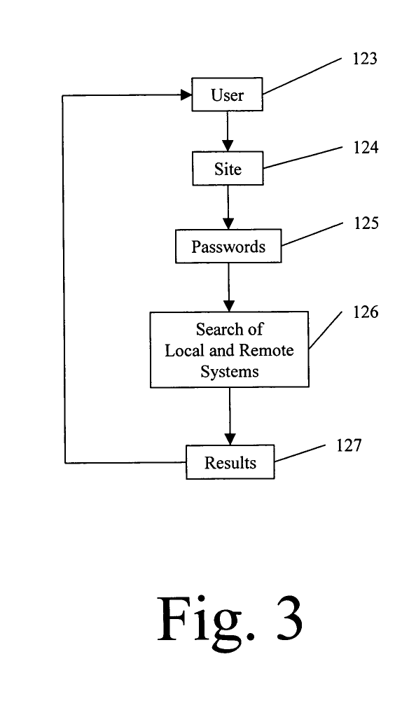

Now referring to FIG. 3, a flow chart of the auto login feature of the present invention is illustrated. A user 123 of the website 124 has the option of storing a plurality of user passwords 125 for any number of other related travel website. When a user requests a search 126 the website 124 of the present invention automatically logs the user into other related website and conducts a search on those website as well. Then the results 127 are returned to the user 123.

For example, a user could have accounts with current popular travel website such as Orbitz and Travelocity. The system of the present invention will conduct a simultaneous search of its own databases and those across multiple travel website such as Orbitz, Expedia, and Travelocity if the user 123 requesting the search has stored with the system of the present invention, the username and passwords for these related travel website by automatically logging into the related travel website for the user and requesting said search.

The auto login feature is designed to allow users 123 to save their usernames and passwords 125 for other systems and automatically log them in to the other systems. This truly brings the entire travel universe together for a user 123 and would cultivate loyalty from users 123 who find it a nuisance to go to other travel website where they wouldn't automatically be logged in to all the travel related website they wish to view. It would also allow the user 123 to have one true portal to the world and, in theory, use one username and password (that of the system of the present invention) on a regular basis. No other system currently known in the prior art has considered this method. Additionally, the auto login feature also may allow the system of the present invention to login to the user accounts of other systems and conduct reporting and data mining functions.

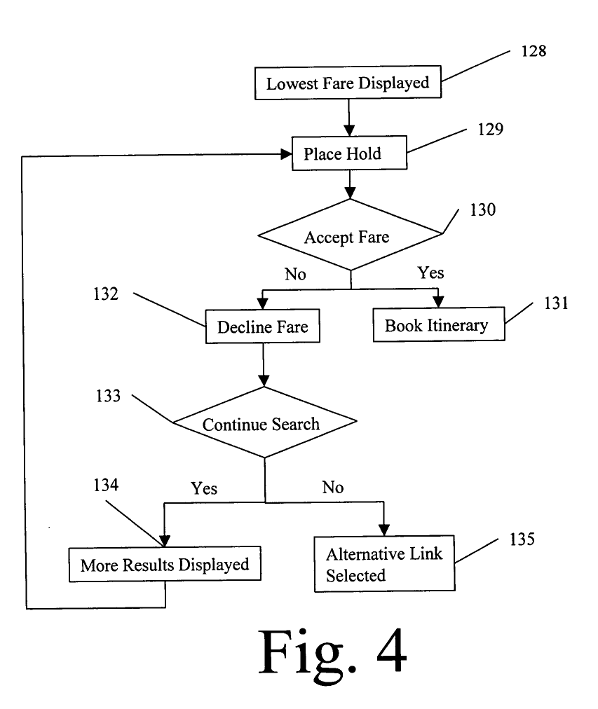

As will be described in detail below, the booking server next generates a search entry and transmits it to the airline reservation system, and receives a return itinerary representing the results of the search. As shown in FIG. 4, in the event that the search failed to uncover a flight meeting the user's specifications that is at or below the user's target price, the lowest available fares are displayed at step 128. The number of fares displayed can be any number, sorted from lowest to highest fare; in the preferred embodiment the two lowest fares are displayed. The user is then given the opportunity to request the booking server to try to hold a seat or seats at one of the displayed fares, at step 129. If the user decides to accept one of the fares by clicking on the appropriate link at step 130, the booking server will book the itinerary at step 131.

If the user does not want to book the flight at the displayed fare, the user clicks on the appropriate link at step 132. The booking server at step 133 then asks the user whether she wishes for the booking server to continue to search for fares meeting or beating the target price. If the user indicates that continued searching is desired, the itinerary and target price file is placed into a search memory at step 134. Otherwise, at step 135, the user clicks on one of a number of alternate links and is taken to the page specified by the link.

Graphical User Interface (GUI)

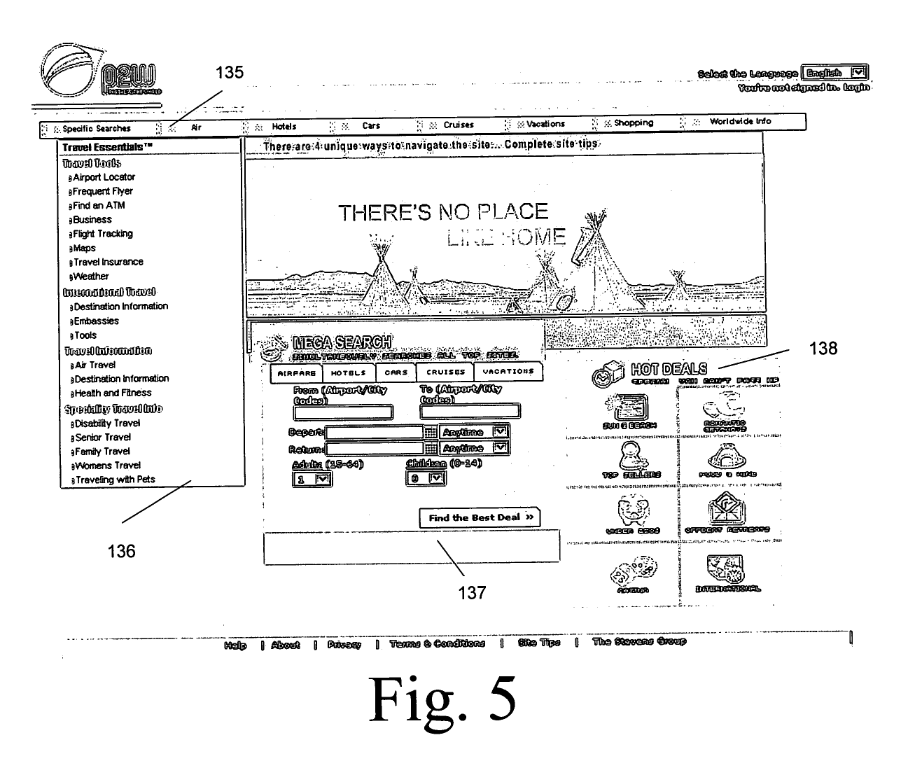

The present invention aims for easy, user-friendly, and intuitive navigation to achieve a positive and lasting user experience. Now referring to FIG. 5, the GUI physical design and placement, title/labels, tabular data, and navigation logic is illustrated. The Homepage GUI 188 consists of six graphical sections: Main Tabs 135, Travel Essentials 136, Mega Search 137, Hot Deals 138, User Login 189, and a Multi-Language Selector Interface.

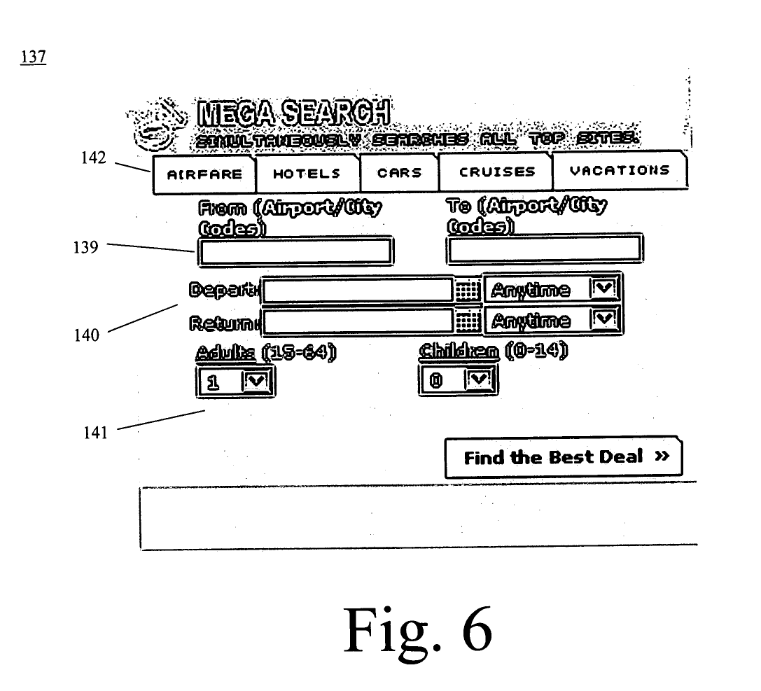

Now referring to FIGS. 6 & 7, the Mega Search 137 and Hot Deals 138 GUIs are illustrated. In FIG. 6, the Mega Search portion consists of a series of tabs 142 which offer the user selection ability to set the first term of the query for a flight, hotel, car, cruise or other ticket or rental purchase they are interest in at that time. After making an industry selection, a geographical information box 139 is provided so that a user can enter to and from information or location data for a rental. Additional time boxes 140 are provided so that a user can further specify their intended us of a ticket or rental to ensure availability as desired. Finally, a group number or party size input 141 is offered.

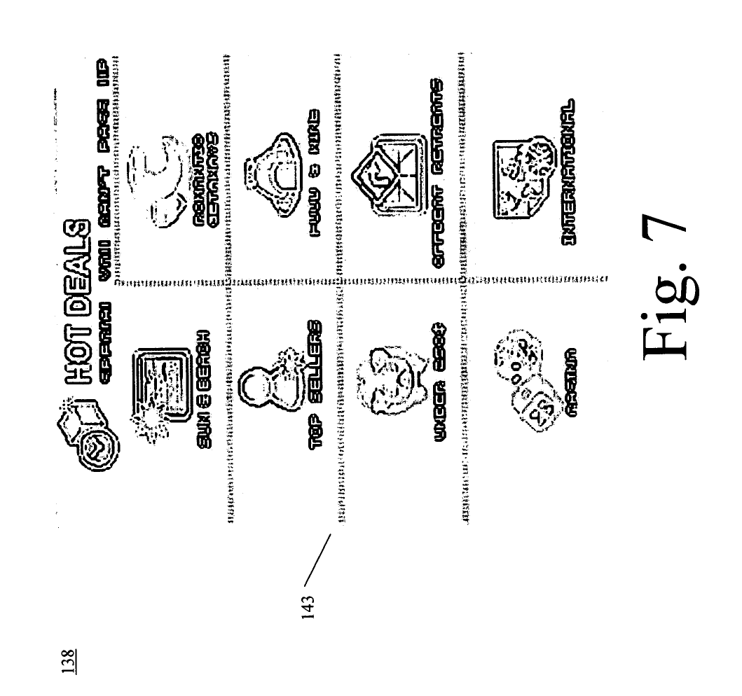

Now referring to FIG. 7, the Hot Deals 138 GUI consists of a plurality of sections 143, each providing a user with quick access to low rate or limited time offers in a variety of categories without the need to enter any detailed information such as that required above for the Mega Search 137.

Portal Technology

Portal Technology allows aggregation of seemingly independent pages, website, or process, into one web page organized into logical sections called portlets or web parts. Portlets may behave as a function of: a scheduled template for seasonal offerings such as “Summer give-aways” and “Valentine destinations”; calculation results from another portlet; third party feeds from an external website providing such information such as breaking news, destinations announcements, and third party promotions—cruise, vacations; customer-specific information based on a login profile; and destination-specific information such as destination events, news, travel guide, and maps based on customer booked destinations.

Portal Technology improves on the prior art by providing a more user-friendly interface that is logical, uncluttered, and easy-to-navigate user interface. The use of dynamic database driven portlets allows for maximum flexibility and ease of administrative use while achieving dynamic content changes from time-based release, database results, or from third-party feeds. Unlike the many systems known in the prior art there are No pop-up and pop-up blocker settings issues. The search results are collated and stored on temporary databases and presented in a tabulated and logical comparative table in the results portlet. From another portlet, search results may be dynamically filtered by price, airline, ETA, ETD, and airport locations. The portal technology of the present invention achieves a consistent graphical interface using Cascading Style Sheets (CSS) for uniform and centralized control of graphical attributes.

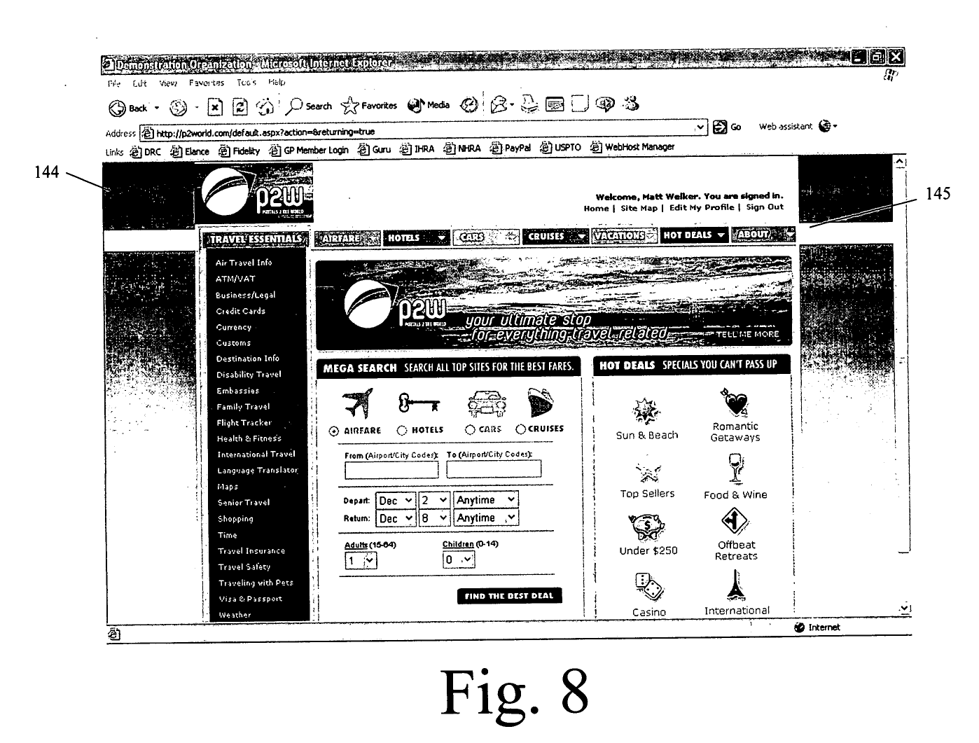

Referring now to FIG. 8, a web page 144 that is part of a graphical user interface for the client process 145 is shown. The web page 144 allows the user to construct a query, which can be executed by the server processor 102 to produce flight plan options for the user. The web page 144 includes a query table 146 that is a tab table 403 here comprised of a multiple tabbed region 145.

For example, as shown in FIG. 8, the table includes a region 137 for entering flight information for a first segment of a flight. The information includes an origin to a destination and information concerning dates and time of travel. The query also allows the user to specify some potential cost saving feature by allowing the user to cause the server to look for other airports within 50 miles of a designated airport and include such other airports in answers for the segment. It also allows a user to specify a travel window.

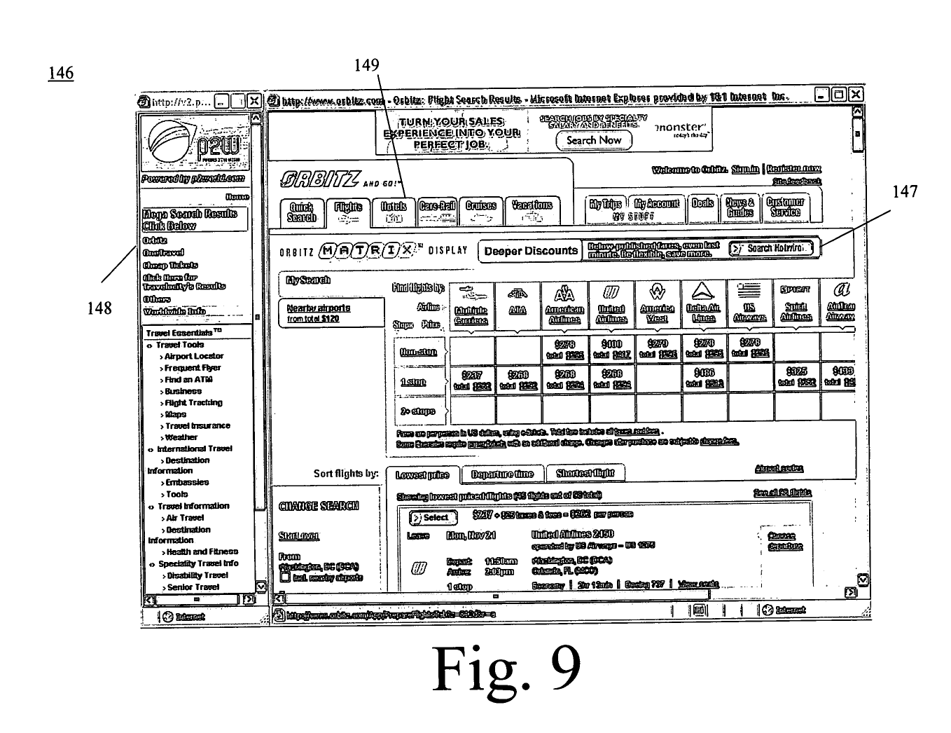

Referring now to FIG. 9, a web page 146 that depicts results from the server process 102 executing a query entered via the query page (FIG. 8) is shown. The web page 146, includes a table 147 that summarizes travel options. As shown in FIG. 9, with the airline tab “Flights” 149 selected, the summary information in the table is displayed with each of the airlines arranged in rows of the table as links and each of the rows of the table 147 arranging specified travel options such as non-stop flights or one-stop flights, as links. Interior cells within the table 147 are links that correspond to prices for each of the airlines with respect to each of the travel options. The table displays a set of air travel options according to specified criteria, e.g., the airlines used in one or more of the travel options and the number of stops or connections in the set of travel options. Here, the travel options represented by a given table cell are those options which use the airline in the same column as that cell, and that have the same number of stops as the “number of stops” header in the same row as that cell. A third criteria, price (i.e. price of an airline ticket), is displayed in each cell of the table; this price is the minimum price for any of the travel options that are represented by a given cell.

As shown in FIG. 9, when the flight time tab 149 is selected, the table 147 is arranged to show departure times between the origin and the destination over ranges of times for the potential days of travel in the outbound portion of the trip in rows of the table, as well as departure time for the return portion of the trip in columns of the table 147 over time ranges in the potential return days. Thus, selecting one of the outer peripheral cells of the table will bring up all flight options on a designated day in the designated time area; whereas selecting an interior cell will produce the intersection of options for a time segment on the selected outbound date and the time segment of the selected return date. The table 147 also depicts the starting or lowest fares for each one of the different time segments allowing a user to decide the most appropriate time to travel giving considerations such as cost and convenience. The graphical user interface is populated by obtaining a list of query-specific travel options.

The process by which the system returns search results is by docketing separate windows for each good or service provider. The docketed windows are controlled and selectable by a navigation window 148 that is docketed next to the results table display 147. A user 123 may view or select which provider results to view by simply selecting the associated link in the navigation window 148. Once a provider's link is selected, the results table display 147 will be changed to show search results for the selected provider.

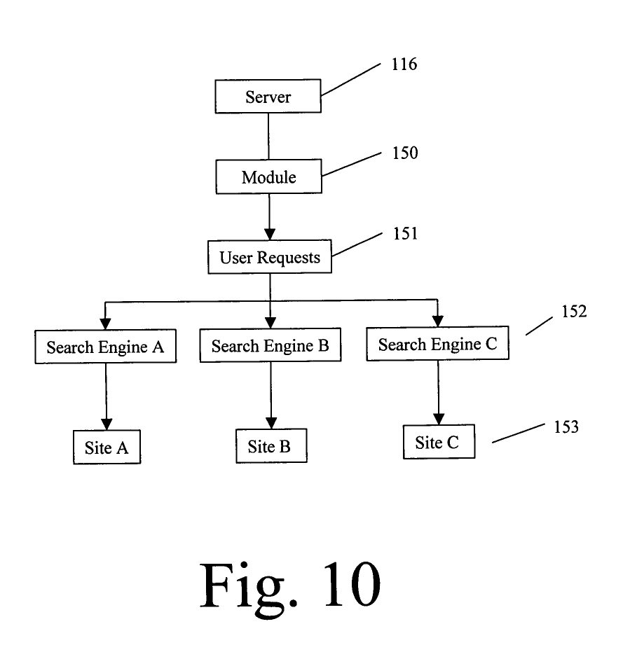

Now referring to FIG. 10, another embodiment that utilizes a mega search approach is illustrated. In this embodiment a module 150 that transmits user search requests 151 to other search engines 152 and simultaneously searches multiple website 153 for the same criteria is utilized. This search approach allows a user to view side-by-side comparisons in one browser window, while maintaining the format for each respective website. With all search results returned simultaneously and readily available, a user may easily switch back and forth between docketed website without delay. Such a system could also easily record user transactions on outside website (i.e. purchases) for reporting purposes.

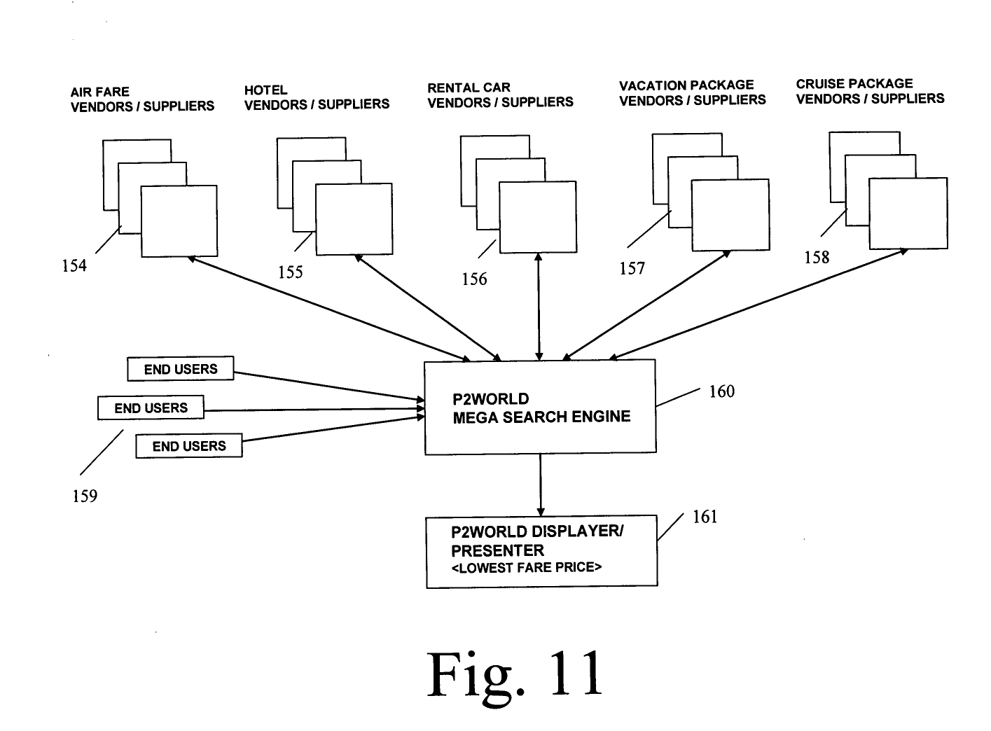

Now referring to FIG. 11, the Mega Search system 137 is composed of three functional blocks: The Sources (vendors and suppliers of travel packages) 154-158, the Mega Search engine 160, and Display/Presenter engine 161 which are required upon an query request from an end user 159.

The Search process starts with the end-user (buyer) entering the search parameters such as, but not limited to: Departure date, From City, To City, and the Number of Travelers (adults+children). Next, the search parameters are passed on the individual travel vendor website, which successively perform its individual search to its own product offering and pricing. The results are displayed on separate windows by vendor offering.

The Mega Search performs simultaneous passing of search parameters to individual Travel Vendor/Suppliers. The search is automatically invoked to simultaneously look for fare prices for the given data parameters. The result is the fastest turn-around known in the prior art, under 30 seconds, to collect and compare multiple fare quotes and options from multiple vendors.

This unique process benefits the consumers in terms of ease of use and maximum convenience by providing a single interface portal to multiple Travel Vendor/Suppliers. Likewise, it provides maximum usability and practicality by reducing the search time to an outstanding 30-second limit.

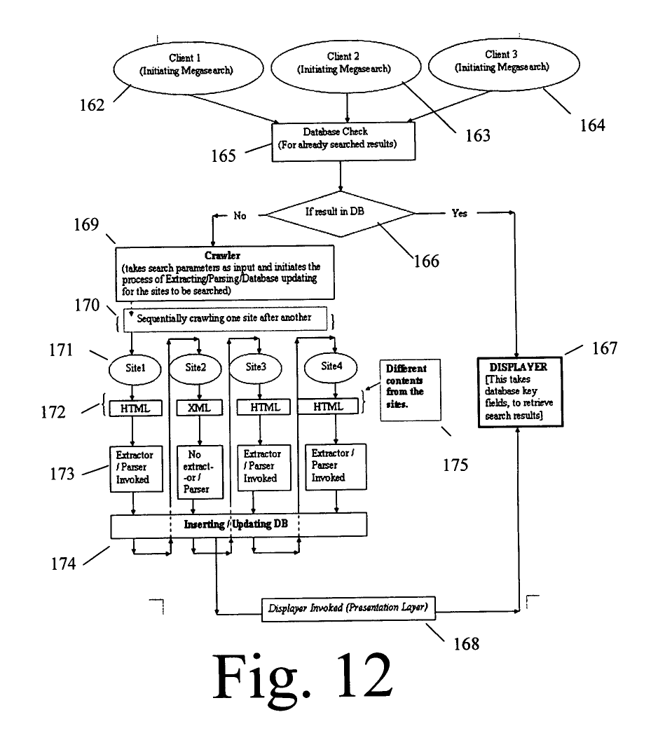

Now referring to FIG. 12, a plurality of clients 162-164 may initiate a search. Upon search initiation, the database is first checked 165 for any previously returned search results that match the query 166. If a previously returned search is found the displayer 167 will return the results to the client. If there are no previous searches the crawler 169 will utilize the search parameters as input and begin the process of extracting, parsing, and database updating for the website to be searched. The crawler then sequentially crawls 170 through a plurality of website 170 reviewing their content 172 in either HTML or XML format, extracting and parsing 173 as required and inserting into a temporary database 174 unit completion. Upon completion of the crawl, where are website have been searched, a presentation 168 is created and sent to the displayer 167 for viewing by the client.

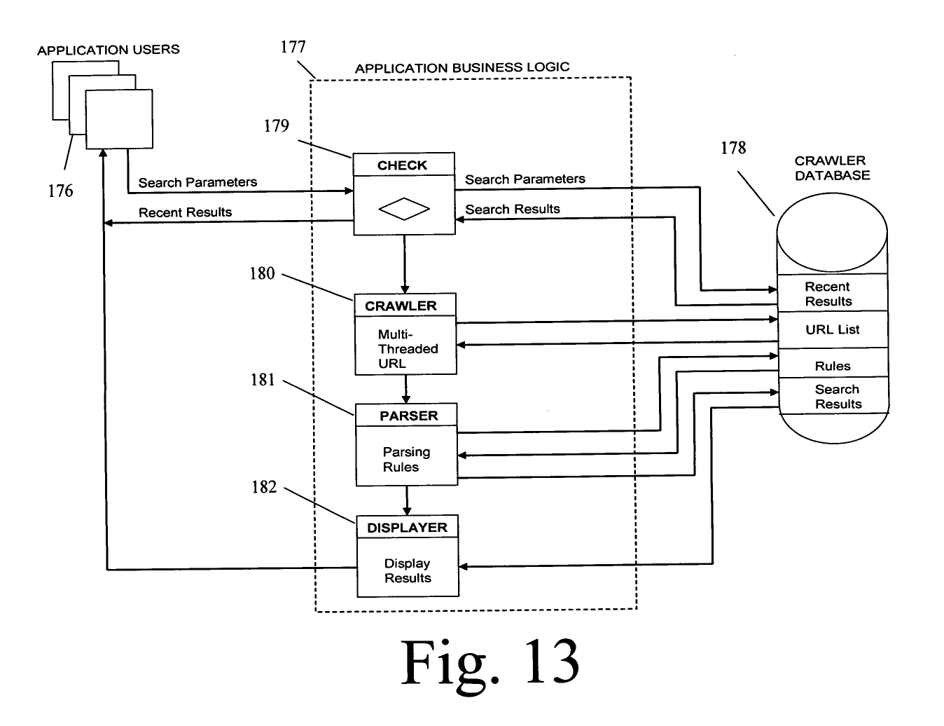

FIG. 13 illustrates the technology architecture behind the Web Crawler. At the heart of the system is the application business logic 177 that consists of four logic elements: Checker 179, Crawler 180, Parser 181, and Displayer 182. All of these elements interact with a Central Database 178 that stores variables, rules, result registers, search website (URL) and search results.

The technology architecture behind the Web Crawler is novel and non-obvious over the prior art as a result of its streamlined process flow which maximizes system response time and achieves faster disk access to database variables.

The Web Crawler also includes a dynamic parameter setup which allows user-defined and/or situation/application defined variables to achieve maximum flexibility and thus adaptability with changing application environment to accommodate variable changes, such as changes in a target website URL addresses or changes in parsing rules in adapting to different application scenarios. For example, target website list includes Travelocity, Orbitz and One Travel. This can be easily and dynamically changed or added with new list by changing the URL list variable register on the database. Likewise, the parse rules can be dynamically changed to look from “Lowest fare” to “Shortest route” (less hop) by changing the parse rule variable register.

The Web Crawler also includes a flexible design which allows the Web Crawler to be used on other applications requiring data extraction, collection, parse, connection, and presentation of logical data results such as price comparison sorted by lowest price from different web-based ecommerce website.

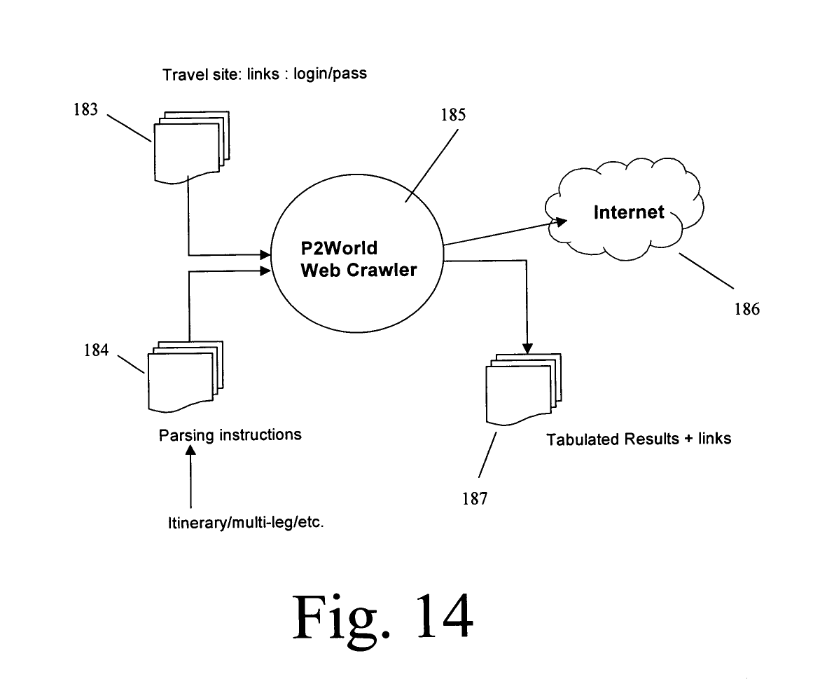

Referring to FIG. 14, a web-crawler 185 is centrally controlled by an administration website that provides interfaces for travel website links 183 (additional search website), parsing routine instructions 184 is provided. Parsed results are tabulated and stored in a temporary database 187. The results are presented to an end user 159 via the Internet or other multi-user network in a tabulated format, sorted by price to achieve logical comparison, and avoid re-direction to travel website, which may have annoying pop-up ads.

Finally, the Multi-Language Selector Interface website of the present invention is architectured to accommodate and present a plurality of languages through a simple language selector drop-down menu or as specified in the preferred language field of the user's profile. Each text or image on the website corresponds to a database table coordinate. Languages are assigned a language ID (e.g., English=1, Spanish=2, etc.). When the language selector ID changes, each text or image will be filled through an SQL database call with the corresponding text or image referenced by that language ID.

This architecture achieves dynamic, on-the-fly, changes of the preferred language for the whole website and enables one to regionalize and globalize the website by reaching to broader and more diverse, multi-language consumer market and corporate customers worldwide

It is appreciated that that while the invention has been described in conjunction with the detailed description thereof; the foregoing description is intended to illustrate and not limit the scope of the invention. Other aspects, advantages, and modifications are within the scope of the following claims. Furthermore, other areas of art may benefit from this method and adjustments to the design are anticipated. Thus, the scope of the invention should be determined by the appended claims and their legal equivalents, rather than by the examples given.

1. A method for booking travel itineraries over a multi-user network comprising the steps of:
a user entering into a centralized website portal, via a graphical user interface, information describing a service desired by said user;
performing a search for aggregated data from multiple travel supplier website acquired through an underlying method and engineering process of collating, extracting, analyzing, and presenting comparative price tables from multiple travel suppliers worldwide, and
informing and presenting to the consumer, via said graphical user interface, said aggregated data from multiple travel supplier website presented through a process of connecting, passing search parameters, presenting and comparing price and offerings from multiple travel package providers worldwide.

2. The method for booking travel itineraries over a multi-user network of claim 1 wherein the graphical user interface incorporates a docketing approach for viewing aggregated data from multiple travel supplier website consisting of docketing multiple websites within a centralized website for retrieval and viewing by a selection process.

3. The method for booking travel itineraries over a multi-user network of claim 1 wherein the graphical user interface incorporates the docking of multiple windows for viewing aggregated data from multiple travel supplier website while simultaneously enabling URLs and cookies for each travel supplier website.

4. The method for booking travel itineraries over a multi-user network of claim 1 wherein the graphical user interface further comprises the ability to dynamically select and present certain travel essentials based upon the method of travel being searched.

5. The method for booking travel itineraries over a multi-user network of claim 1 wherein the method for obtaining aggregate search results from multiple travel supplier website is a simultaneous search that executes the same search query simultaneously on multiple website and then presents the results in their original website form from the travel supplier website within the graphical user interface.

6. The method for booking travel itineraries over a multi-user network of claim 1 wherein the method for obtaining aggregate search results from multiple travel supplier website is a simultaneous search that executes, simultaneously, the same search on many website, but gathers the results returned and displays all fares on one website in the graphical user interface of the centralized website portal, then, when a user selects a product to purchase, said user is directed to the travel supplier website to make the purchase.

7. The method for booking travel itineraries over a multi-user network of claim 1 further comprising a user account manager that stores personal user names and passwords from external web website and allows a user to be automatically logged in to travel supplier website through the centralized website portal.

8. The method for booking travel itineraries over a multi-user network of claim 7 including the additional step of gathering purchase and transaction information from multiple travel web website for reporting at an individual, group or other aggregate level.

9. The method for booking travel itineraries over a multi-user network of claim 7 including the additional step of gathering purchase and transaction information from multiple travel web website for providing a consolidated personal view of future and historical travel.

10. The method for booking travel itineraries over a multi-user network of claim 1 wherein the method and engineering process of collating, extracting, analyzing, and presenting comparative price tables from multiple travel suppliers worldwide is comprised of:
an application business logic module that consists of four logic elements:
a Checker,
a Crawler,
a Parser, and
a Displayer;
said logic elements interact with a Central Database that stores variables, rules, result registers, search website and search results;
a dynamic parameter setup allows user-defined and application defined variables to achieve maximum flexibility and thus adaptability with changing application environment to accommodate variable changes.

11. The method for booking travel itineraries over a multi-user network of claim 10 wherein the parser's rules can be dynamically changed to look from “Lowest fare” to “Shortest route” by changing the parse rule variable register.

12. The method for booking travel itineraries over a multi-user network of claim 1 wherein the graphical user interface of the centralized website portal further comprises a method and architecture to deliver multiple language website by simple user selection of a preferred language either through the user's profile information or via a language selector field.

13. The method for booking travel itineraries over a multi-user network of claim 12 wherein a multi-language selector interface is architectured to accommodate and present a plurality of languages through a simple language selector drop-down menu or as specified in the preferred language field of the user's profile.

14. The method for booking travel itineraries over a multi-user network of claim 12 wherein the architecture to deliver multiple language website requires that each text or image on a website to correspond to a database table coordinate where languages are assign a language ID and when the language selector ID changes, each text or image will be filled through a database call with the corresponding text or image referenced by that language ID.

15. The method for booking travel itineraries over a multi-user network of claim 14 wherein the architecture achieves dynamic changes of the preferred language for a whole website and enables a user to regionalize or globalize the website by reaching to a multi-language consumer market.

16. A computer program product comprising instructions for causing a computer to:
catalog and lists all other website via a centralized interface;
displaying other website within the centralized catalog's interface and allowing users to view multiple travel website without leaving the core catalog;
a first module that tracks specific users by organization and subdivision;
a second module which transmits user search requests to other search engines and simultaneously searches multiple website for the same criteria and allows for side-by-side comparison in one browser window; and displays the results in their own website; and
allows for users to switch back and forth between website without delay; and records user transactions on outside website for reporting;
a system which allows an organization to have a specially branded website; and
wherein said system allows organizations to administer users on their website; and view transactions made by users; and produces reports based on subdivision of organization.

17. The method for booking travel itineraries over a multi-user network of claim 1 wherein said travel itinerary includes airfare, hotel reservations, car rental, cruise bookings, or and vacation packages.

18. The computer program of claim 16 wherein said simultaneously searches of multiple website is limited to website selling tangible goods.

19. The computer program of claim 16 wherein said simultaneously searches of multiple website is limited to website selling travel services.
